(19) United States
(12) Patent Application Publication
(10) Pub. No.: US 2016/0274813 A1
(43) Pub. Date: Sep. 22, 2016

(54) STORAGE SYSTEM MANAGEMENT AND REPRESENTATION METHODS AND APPARATUS

(71) Applicant: INTERMODAL DATA, INC., Santa Clara, CA (US)

(72) Inventors: Cahya Adiansyah Masputra, San Jose, CA (US); Prashanth K. Sreenivasa, Milpitas, CA (US); Kais Belgaied, San Jose, CA (US); Donald James Brady, Woodland Park, CO (US); Richard Michael Elling, Ramona, CA (US)

(21) Appl. No.: 15/070,683

(22) Filed: Mar. 15, 2016

Related U.S. Application Data
(60) Provisional application No. 62/133,758, filed on Mar. 16, 2015.

(51) Int. Cl. G06F 3/06

(52) U.S. Cl. CPC G06F 3/0629; G06F 3/0604; G06F 3/067

(57) ABSTRACT

A system, method, and apparatus for managing and graphically representing a Layer-2 storage service are disclosed. An example apparatus includes a node manager processor configured to receive information indicating a configuration of a storage resource from a third-party service provider of the storage resource and make the storage resource available to users of a Layer-2 storage system. The apparatus also includes a platform processor configured to receive a request from a user to create a Layer-2 storage service that specifies the storage resource for inclusion within the Layer-2 storage service. Responsive to the request, the platform processor is configured to create the Layer-2 storage service that includes an instance of the storage resource as configured by the third-party service provider. The platform processor is also configured to create a graphical representation of the storage service including the storage resource.

### PRIORITY CLAIM

The present application claims priority to and the benefit of U.S. Provisional Patent Application No. 62/133,758, filed on Mar. 16, 2015, the entirety of which is incorporated herein by reference.

### BACKGROUND

Known storage services are generally a labyrinth of configuration settings and tools. Any given storage service includes a combination of physical and virtualized hardware combined with software-based storage rules and configurations. Each hardware and software resource of the storage service is typically designed or provided by a third-party provider. A storage service provider makes the hardware and software storage resources available in a central location to provide users with an array of different data storage solutions. Users access the storage service provider to specify a desired storage service. However, the storage service providers generally leave the complexity involved in combining hardware and software resources provided by different third-party providers to the users. This combination of different third-party hardware/software storage resources oftentimes creates an overly complex mesh of heterogeneous, unstable storage resource management tools and commands. Frequently, inputs, outputs, and behaviors of the different tools are inconsistent or counterintuitive, which further complicates a user's management (or even management by the storage service provider) of a storage service. Additionally, updates to the underlying storage resources by the third-party providers have to be properly integrated and propagated through the storage services while maintaining consistent system performance, with the updates being properly communicated to the appropriate individuals. Otherwise, configurations between the different storage resources may become misaligned or faulty.

Companies and other entities (e.g., users) that use storage services typically employ specialized storage system experts to navigate the storage system labyrinth and handle updates to the underlying resources. The system experts are knowledgeable regarding how to use the third-party storage system tools for configuring and maintaining the corresponding storage system resources to create a complete storage service. Such experts adequately preform relatively simple storage configurations or operations. However, experts become overburdened or exposed when trying to formulate relatively complex storage operations, which generally involves multiple compound storage operations. There is accordingly a significant cost to implement, triage, and maintain relatively complex storage systems and exponential costs to address failures. Further, many small to medium-sized users cannot afford the relatively high cost of experts to implement even a relatively simple storage service.

### SUMMARY

The present disclosure provides a new and innovative system, method, and apparatus for managing and graphically representing a Layer-2 storage service. An example storage service provider is configured to enable users to specify and create a Layer-2 storage service that includes storage or system resources provided by third-parties. The storage service provider tracks which storage resources are used within each storage service to enable the third-parties to provide updates or changes to the storage resources without affecting the storage services. The storage service provider uses the tracking of the storage resources to create graphical representations that show abstracted, consistent, unified, and common views of storage resources and/or the storage services to enable streamlined storage services management.

In an embodiment, an apparatus includes a node manager processor configured to receive information indicating a configuration of a storage resource from a third-party service provider of the storage resource, the information including a resource data structure that includes at least one object of the storage resource. The node manager processor is also configured to make the storage resource available to users of a Layer-2 storage system. The apparatus also includes a platform processor configured to receive a request from a user to create a Layer-2 storage service that specifies the storage resource for inclusion within the Layer-2 storage service. Responsive to the request, the platform processor creates the Layer-2 storage service that includes an instance of the storage resource as configured by the third-party service provider. The platform processor is further configured to create a graphical representation of the Layer-2 storage service including the storage resource, the graphical representation including at least one node corresponding to the at least one object. Moreover, the platform processor is configured to transmit the graphical representation of the storage service to the user.

In another embodiment, a storage service management method includes receiving in a node manager processor a request from a user device to create a storage service, the request including an indication to include a storage resource within the storage service. The method also includes creating via the node manager processor the storage service including the storage resource and at least one object of the storage resource and detecting via a system events handler the creation of the storage service. The method further includes creating via a platform processor a graphical representation of the storage service including the storage resource and the at least one object after detecting the creation of the storage service. The method moreover includes transmitting to the user device at least one of the graphical representation of the storage service and graphical representation information indicating how the graphical representation is to be generated by the user device.

Additional features and advantages of the disclosed system, method, and apparatus are described in, and will be apparent from, the following Detailed Description and the Figures.

### BRIEF DESCRIPTION OF THE FIGURES

FIG. 1 shows a diagram of a storage service environment including a node manager and a platform expert, according to an example embodiment of the present disclosure.

FIG. 2 shows a diagram of an example graphical representation of a storage service, according to an example embodiment of the present disclosure.

FIG. 3 shows a diagram of access layers to the example node manager of FIG. 1, according to an example embodiment of the present disclosure.

FIGS. 4A, 4B, 5, 6, and 7 illustrate flow diagrams showing example procedures to create, destroy, and import a storage service using the example node manager and/or the platform expert of FIGS. 1 to 3, according to example embodiments of the present disclosure.

### DETAILED DESCRIPTION

The present disclosure relates in general to a method, apparatus, and system for providing management and representation of storage services and, in particular, to a method, apparatus, and system that provides an abstracted, consistent, unified, and common view of storage service resources and/or storage services to enable streamlined storage services management. The example method, apparatus, and system disclosed herein include a node manager (e.g., a server or processor) and a platform expert (e.g., a server or processor) configured to provide management and control of storage services (e.g., storage pools). As disclosed in more detail below, the example node manager is configured to enable users to specify a storage service and accordingly create/provision the storage service. The example node manager is also configured to enable third-party providers of hardware and software to access/update/configure the underlying storage resources and propagate those changes through the plurality of hosted storage services. The example platform expert is configured to provide users and other administrators control plane management and visibility of the hardware/software storage resources that comprise a storage service.

As disclosed herein, a user includes an individual, a company, or other entity that uses or otherwise subscribes to a storage service. A user includes an administrator or other person/entity tasked with requesting, modifying, or otherwise managing a storage service. A user also includes employees or other users of a storage service. A user accesses a storage service via a user device, which may include any computer, laptop computer, server, tablet computer, workstation, smartphone, smartwatch, smart-eyewear, etc.

A storage service provider includes an entity configured to provide storage services to one or more users based, for example, on a service level agreement (“SLA”). A storage service provider hosts or otherwise manages a suite of hardware and/or software storage resources (e.g., system resources) that are combinable and/or configurable based on the storage requirements of a user. Collectively, a configuration of hosted hardware and/or software storage resources provisioned for a user is a storage service. Each storage resource includes one or more objects or parameters that define or otherwise specify how the storage resource is to be provisioned, configured, or interfaced with other storage resources.

Hardware storage resources may include physical devices such as, for example, solid state drives (“SSDs”), hard disk drives (“HDDs”), small computer system interfaces (“SCSIs”), serial attached SCSI (“SAS”) drives, near-line (“NL”)-SAS drives, serial AT attachment (“ATA”) (“SATA”) drives, dynamic random-access memory (“DRAM”) drives, synchronous dynamic random-access memory (“SDRAM”) drives, etc. Hardware storage resources may be virtualized across one or more physical drives. Software storage resources include configurations and/or protocols used to configure the physical resources. For instance, software resources may include network protocols (e.g., ATA over Ethernet (“AoE”)), file system specifications (e.g., network file system (“NFS”) specifications, data storage configurations (e.g., redundant array of independent disks (“RAID”) configurations), volume manager specifications (e.g., a ZFS volume manager), etc.

As disclosed herein, third-party providers design, develop, produce, and/or make available the hardware and/or software storage resources for the storage service providers. For example, a third-party provider may manufacture an SSD that is owned and operated by a storage service provider. In another example, a third-party provider provides a combined file system and logical volume manager for use with virtualized storage drives. In these examples, the third-party providers specify configurations for the resources used by the storage service provider. The third-party providers may also periodically update or change the configurations of the resources (e.g., a firmware or software update to address bugs or become forward compatible).

While the example, method, and apparatus disclosed herein use a Layer-2 Ethernet communication medium that includes AoE as the network protocol for communication and block addressing, it should be appreciated that the example, method, and apparatus may also be implemented using other protocols within Layer-2 including, for example, Address Resolution Protocol (“ARP”), Synchronous Data Link Control (“SDLC”), etc. Further, the example, method, and apparatus may further be implemented using protocols of other layers, including, for example, Internet Protocol (“IP”) at the network layer, Transmission Control Protocol (“TCP”) at the transport layer, etc.

### Example Storage Service Environment

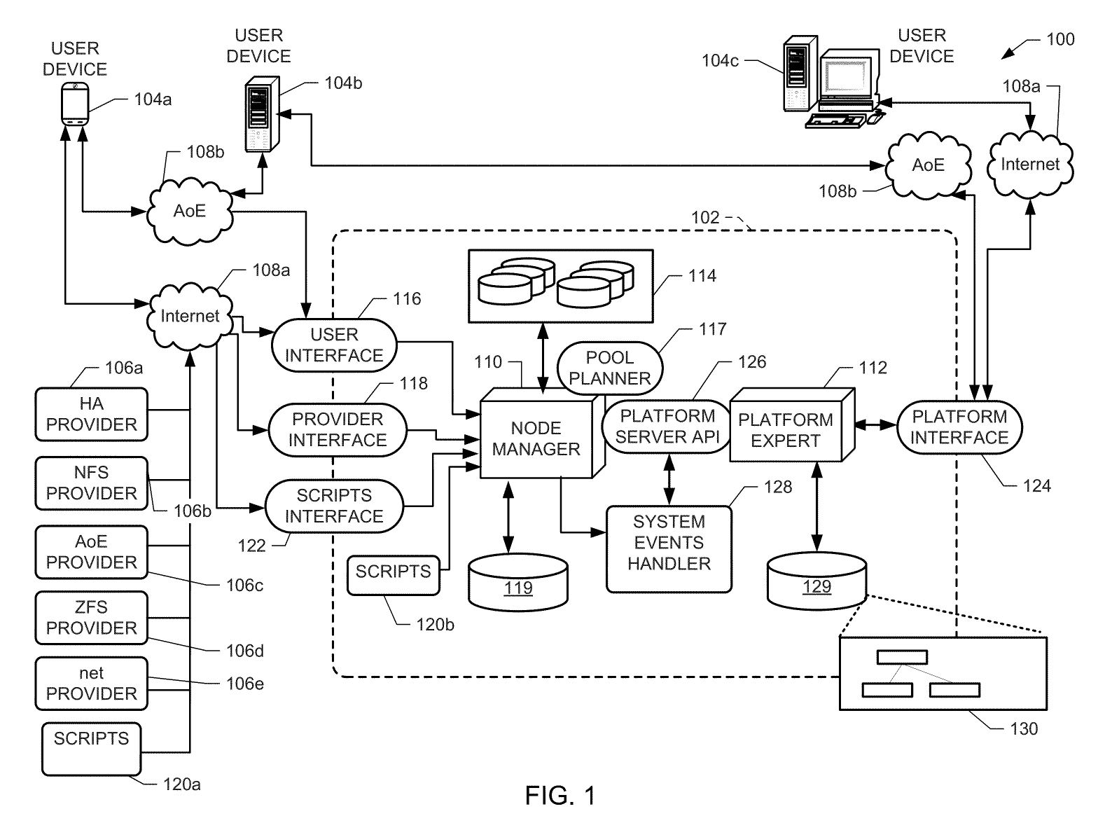

FIG. 1 shows an example storage service environment 100, according to an example embodiment of the present disclosure. The example environment 100 includes a storage service provider 102, user devices 104, and third-party providers 106. The provider 102, user devices 104, and/or third-party providers 106 are communicatively coupled via one or more networks 108 including, for example, the Internet 108a and/or an AoE network 108b. As mentioned above, the user devices 104 may include any computer, laptop computer, server, processor, workstation, smartphone, tablet computer, smart-eyewear, smartwatch, etc. The example third-party providers 106 include a high-availability (“HA”) storage provider 106a, a NFS provider 106b, an AoE provider 106c, a ZFS provider 106d, and a NET provider 106e. It should be appreciated that the example environment 100 can include fewer or additional third-party providers including, for instance, third-party providers for physical and/or virtual storage drives.

The example storage service provider 102 is configured to provide storage services to users and includes a node manager 110 and a platform expert 112. The example storage service provider 102 also includes (or is otherwise communicatively coupled to) storage devices 114 that are configured to provide or host storage services for users. The storage devices 114 may be located in a centralized location and/or distributed across multiple locations in, for example, a cloud computing configuration. Further, while the storage service provider 102 is shown as being centralized, it should be appreciated that the features and/or components of the provider 102 may be distributed among different locations. For example, the node manager 110 may be located in a first location and the platform expert 112 may be located in a second different location. Moreover, while FIG. 1 shows the node manager 110 and the platform expert 112 as being included within the storage service provider 102, it should be appreciated that either or both of the devices 110 and 112 may be implemented or operated by another entity and communicatively coupled via one or more networks. The node manager 110 and/or the platform expert 112 may be implemented by one or more devices including servers, processors, workstations, cloud computing frameworks, etc. The node manager 110 may be implemented on the same device as the platform expert 112. Alternatively, the node manager 110 may be implemented on a different device from the platform expert 112.

Further, it should be appreciated that at least some of the features of the platform expert 112 may additionally or alternatively be performed by the node manager 110. For example, in some embodiments the node manager 110 may be configured to abstract and graphically (or visually) represent a storage service. Likewise, at least some of the features of the node manager 110 may additionally or alternatively be performed by the platform expert 112. The node manager 110 and/or the platform expert 112 (or more generally the storage service provider 102) may include a machine-accessible device having instructions stored thereon that are configured, when executed, to cause a machine to at least perform the operations and/or procedures described above and below in conjunction with FIGS. 1 to 7.

The node manager 110 may also include or be communicatively coupled to a pool planner 117. The example pool planner 117 is configured to select drives (e.g., portions of the storage devices 114), objects, and/or other resources based on criteria, requirements, specifications, or SLAs provides by users. The pool planner 117 may also build a configuration of the storage devices 114 based on the selected drives, objects, parameters, etc. In some instances, the pool planner 117 may use an algorithm configured to filter drives based on availability and/or user specifications.

The example node manager 110 is configured to provision and/or manage the updating of the storage devices 114. For instance, the node manager 110 enables users to perform or specify storage specific operations for subscribed storage services. This includes provisioning a new storage service after receiving a request from a user. The example storage service provider 102 includes a user interface 116 to enable the user devices 104 to access the node manager 110. The user interface 116 may include, for example, a Representational State Transfer (“REST”) application programmable interface (“API”) and/or JavaScript Object Notation (“JSON”) API.

The example node manager 110 is also configured to enable the third-party providers 106 to update and/or modify objects of storage resources hosted or otherwise used within storage services hosted by the storage service provider 102. As mentioned above, each third-party provider 106 is responsible for automatically and/or proactively updating objects associated with corresponding hardware/software storage resources. This includes, for example, the NFS provider 106b maintaining the correctness of NFSs used by the storage service provider 102 within the storage devices 114. The example storage service provider 102 includes a provider interface 118 that enables the third-party providers 106 to access the corresponding resource. The provider interface 118 may include a REST API, a JSON API, or any other interface.

The third-party providers 106 access the interface 118 to request the node manager 110 to update one or more objects/parameters of a storage resource. In other embodiments, the third-party providers 106 access the interface 118 to directly update the objects/parameters of a storage resource. In some embodiments, the third-party providers 106 may use a common or global convention to maintain, build, and/or populate storage resources, objects/parameters of resources, and/or interrelations of storage resources. Such a configuration enables the node manager 110 via the third-party providers 106 to create (and re-create) relationships among storage resources in a correct, persistent, consistent, and automated way without disrupting storage services.

As disclosed herein, persistent relationships among storage resources means that the creation, updating, or deletion of configuration information outlives certain events. These events include graceful (e.g., planned, user initiated, etc.) and/or abrupt (e.g., events resulting from a software or hardware failure) restarting of a storage system. The events also include the movement of a service within a HA cluster and/or a migration of a storage pool to a different cluster such the migrated storage pool retains the same configuration information. In other words, a persistent storage resource has stable information or configuration settings that remain the same despite changes or restarts to the system itself.

The example node manager 110 of FIG. 1 is communicatively coupled to a resource data structure 119 (e.g., a memory configured to store resource files). The resource data structure 119 is configured to store specifications and/or copies of third-party storage resources. In the case of software-based storage resources, the data structure 119 stores one or more copies (or instances) of configured software that may be deployed to hardware storage resources or used to configure hardware resources. The data structure 119 may also store specifications, properties, parameters, or requirements related to the copied software (or hardware) storage resources. The specifications, properties, parameters, or requirements may be defined by a user and/or the third-party.

The node manager 110 is configured to use instances of the stored storage resources to provision a storage service for a user. For instance, the node manager 110 may copy a ZFS file manager (i.e., a software storage resource) from the data structure 119 to provision a storage pool among the storage devices 114. The ZFS file manager may have initially been provided to the node manager 110 (and periodically updated) by the ZFS provider 106d. In this instance, the node manager 110 configures the storage pool to use the ZFS file manager, which is a copied instance of the ZFS manager within the data structure 119.

The example node manager 110 is also configured to store to the data structure 119 specifications, parameters, properties, requirements, etc. of the storage services provisioned for users. This enables the node manager 110 to track which resources have been instantiated and/or allocated to each user. This also enables the node manager 110 (or the third-party providers 106) to make updates to the underlying resources by being able to determine which storage services are configured with which storage resources.

The example storage service provider 102 also uses scripts 120 to enable users to manage storage resources. The scripts 120 may include scripts 120a that are external to the storage service provider 102 (such as a HA service), which may be provided by a third-party and scripts 120b that are internal to the storage service provider 102 (such as a pool planner script). The external scripts 120a may access the storage resources at the node manager 110 via a script interface 122. The scripts 120 may include tools configured to combine storage resources or assist users to specify or provision storage resources. For instance, a pool planning script may enable users to design storage pools among the storage devices 114.

The example storage service provider 102 also includes a platform expert 112 that is configured to provide users a consistent, unified, common view of storage resources, thereby enabling higher level control plane management. The platform expert 112 is configured to determine associations, dependencies, and/or parameters of storage resources to construct a single point of view of a storage service or system. In other words, the platform expert 112 is configured to provide a high level representation of a user's storage service by showing objects and interrelationships between storage resources to enable relatively easy management of the storage service without the help from expensive storage system experts. This storage resource abstraction (e.g., component abstraction) enables the platform expert 112 to determine and provide a more accurate and reduced (or minimized) view of a storage service that is understandable to an average user.

The platform expert 112 is configured to be accessed by the user devices 104 via a platform interface 124, which may include any REST API, JSON API, or any other API or web-based interface. In some embodiments, the platform interface 124 may be combined or integrated with the user interface 116 to provide a single user-focused interface for the storage service provider 102. The platform expert 112 is also configured to access or otherwise determine resources within storage services managed by the node manager 110 via a platform expert API 126, which may include any interface. In some embodiments, a system events handler 128 is configured to determine when storage services are created, modified, and/or deleted and transmit the detected changes to the platform expert 112.

The example platform expert 112 is configured to be communicatively coupled to a model data structure 129, which is configured to store graphical representations 130 of storage services. As discussed in more detail below, a graphical representation 130 provides a user an abstracted view of a storage service including underlying storage resources and parameters of those resources. The example graphical representation 130 also includes features and/or functions that enable a user to change or modify objects or resources within a storage service.

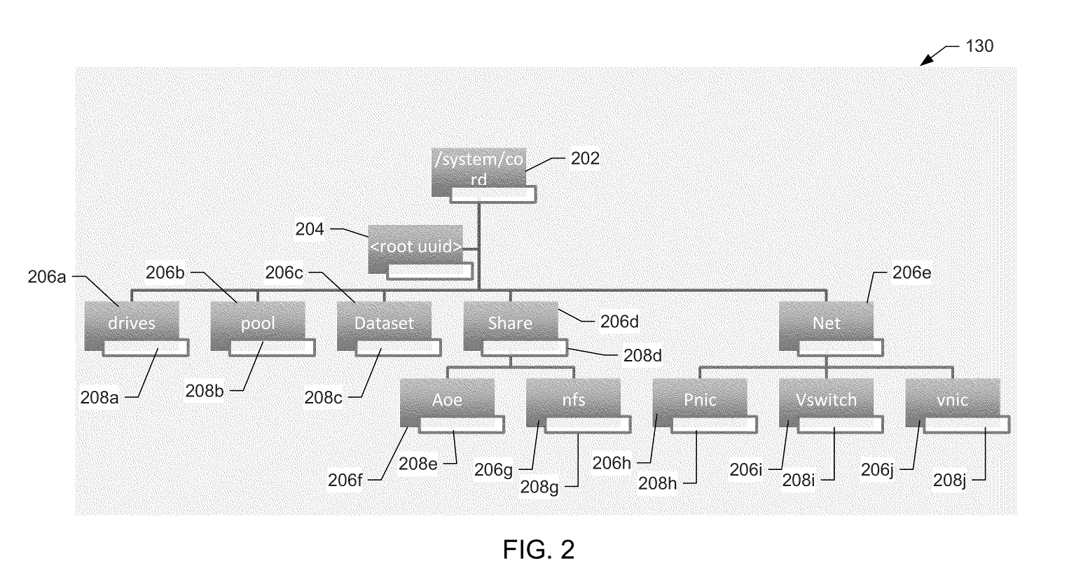

FIG. 2 shows a diagram of an example graphical representation 130 of a storage service, according to an example embodiment of the present disclosure. The graphical representation 130 represents or abstracts a storage service and underlying software and/or hardware storage resources into a resource-tree structure that displays objects/parameters and relationships between resources/objects/parameters. Each storage service provisioned by the node manager 110 among the storage devices 114 includes a root address 202 and a universally unique identifier (“UUID”) 204. The storage service also includes hardware and software storage resources 206 (e.g., the storage resources 206a to 206j), which are represented as nodes within the resource-tree structure. Each of the nodes 206 represents at least one object and is assigned its own UUID. The node or object specifies or includes at least one immutable and/or dynamic parameter 208 (e.g., the parameters 208a to 208j) related to the respective storage resource. The parameters may include, for example, status information of that storage resource (e.g., capacity, latency, configuration setting, etc.). The parameters may also include, for example, statistical information for that object and/or resource (e.g., errors, data access rates, downtime/month, etc.). The use of the UUIDs for each object enables the platform expert 112 to abstract physical hardware to a naming/role convention that allows physical and/or virtual objects to be treated or considered in the same manner. As such, the platform expert 112 provides users a mapping to the physical hardware resources in conjunction with the software resources managing the data storage/access to the hardware.

The example platform expert 112 is configured to create the graphical representation 130 based on stored specifications of the storage resources that are located within the resource data structure 119. In an example, the platform expert 112 uses the platform expert API 126 and/or the system events handler 128 to monitor the node manager server 110 for the creation of new storage services or changes to already provisioned storage services. The platform expert 112 may also use one or more platform libraries stored in the data structure 129, which define or specify how certain storage resources and/or objects are interrelated or configured.

For instance, the system events handler 128 may be configured to plug into a native events dispatching mechanism of an operating system of the node manager 110 to listen or monitor specified events related to the provisioning or modifying of storage services. After detecting a specified event, the example system events handler 128 determines or requests a UUID of the storage service (e.g., the UUID 204) and transmits a message to the platform expert 112. After receiving the message, the example platform expert 112 is configured to make one or more API calls to the node manager 110 to query the details regarding the specified storage service. In response, the node manager 110 accesses the resource data structure 119 to determine how the specified storage service is configured and sends the appropriate information to the platform expert 112. The information may include, for example, configurations of hardware resources such as device type, storage capacity, storage configuration, file system type, attributes of the file system and volume manager, etc. The information may also include parameters or objects of the resources and/or defined interrelationships among the resources and/or objects. The example platform expert 112 is configured to use this information to construct the graphical representation 130 using, in part, information from the platform libraries. For instance, a library may define a resource tree structure for a particular model of SSD configured using a RAID01 storage configuration.

The example platform expert 112 is also configured to assign UUIDs to the storage resources and/or objects. The platform expert 112 stores to the data structure 129 a reference of the UUIDs to the specific resources/objects. Alternatively, in other embodiments, the node manager 110 may assign the UUIDs to the resources/objects at the time of provisioning a storage service. In some instances, a library file may define how resources and/or objects are to be created and/or re-created within a graphical representation 130. This causes the platform expert 112 to create and re-create different instances of the same resources/objects in a correct, repeatable (persistent), consistent, and automated way based on the properties (e.g., class, role, location, etc.) of the resource or object. For example, the platform expert 112 may be configured to use a bus location of a physical network interface controller (“NIC”) (e.g., a hardware storage resource) to determine a UUID of the resource. The bus location may also be used by the platform expert 112 to determine the location of the NIC resource within a graphical representation 130.

The code (e.g., an output from a JSON interface) below shows an example specification of a graphical representation determined by the platform expert 112. The code includes the assignment of UUIDs to storage resources and the specification of objects/parameters to the resources.

```
/system/cord$ json -f share/aoe/0e52855b-a25c-59dd-b553-a24a8ce98e5c/
devnode.json
{
      “uuid”: “0e52855b-a25c-59dd-b553-a24a8ce98e5c”,
      class”: “aoetlu”,
      “dataset_uuid”: “79a94913-b2ce-5748-b50c-6a44684bbaa0”,
      “aoe_pool_num”: “42”,
      aoe_vol_num”: “17”,
      filename”: “/aoe_luns/aoe_pool42_vol17/aoet_lu_42_17”,
      role”: “netdrv”,
      guid”: “600100400C008C370000546B822F0045”,
      “size”: “1099511627776”,
      “write_protect”: “false”,
      “write_cache_enable”: “true”,
      “version”: “1.0”,
      “actionable”: “yes”
}
```

The code below shows another example specification of a graphical representation determined by the platform expert 112. The code includes the assignment of UUIDs to storage resources and the specification of objects/parameters to the resources.

```
[root@congo /var/tmp/cord-python]# json -f
/system/cord/share/nfs/177df742-43dd-590f-b6ce-
7d072fd11ad4/devnode.json
{
      “uuid”: “177df742-43dd-590f-b6ce-7d072fd11ad4”,
      “type”: “NFSv3”,
      “dataset_uuid”: “8174c679-b430-5dec-b2b4-1dd4b1f0c2b7”,
      “version”: “1.0”,
      “actionable”: “yes”
}
[root@congo /var/tmp/cord-python]# json -f
/system/cord/dataset/8174c679-b430-5dec-b2b4-
1dd4b1f0c2b7/devnode.json
{
      “class”: “dataset”,
      “actionable”: “yes”,
      “version”: “1.0”,
      “name”: “demo_nfs_datastore”,
      “dataset_name”: “cordstor-
      27797606/nfs/demo_nfs_datastore”,
      “uuid”: “8174c679-b430-5dec-b2b4-1dd4b1f0c2b7”,
      “type”: “FILESYSTEM”,
      “creation”: “2014-11-18T17:34:40Z”,
      “used”: “19456”,
      “available”: “21136607657984”,
      “referenced”: “19456”,
      “logicalused”: “9728”,
      “logicalreferenced”: “9728”,
      “compressratio”: “1.00”,
      “refcompressratio”: “1.00”,
      “quota”: “0”,
      “reservation”: “0”,
      “refquota”: “0”,
      “refreservation”: “0”,
      “compression”: “OFF”,
      “recordsize”: “131072”,
      “mounted”: “YES”,
      “mountpoint”: “/nfs_shares/demo_nfs_datastore”,
      “usedbysnapshots”: “0”,
      “usedbydataset”: “19456”,
      “usedbychildren”: “0”,
      “usedbyrefreservation”: “0”,
      “sync”: “STANDARD”,
      “written”: “19456”,
      “pool_uuid”: “57356387-1caf-59f5-9273-8033ca0d8d06”,
      “protocol”: “NFS”,
      “coraid:share”: “{ \“type\”: \“NFSv3\” }”
}
```

The platform expert 112 is also configured to enable users to modify the underlying resources and/or objects of a storage service via the graphical representation 130. As described, the graphical representation 130 provides an abstracted view of a storage service including underlying resources/objects. Accordingly, a user's manipulation of the graphical representation 130 enables the platform expert 112 to communicate the changes to the resources/objects to the node manager 110, which then makes the appropriate changes to the actual storage service. An expert is not needed to translate the graphical changes into specifications hardcoded into a file system or storage system. For instance, the platform expert 112 may provide one or more applications/tools to enable users to view/select additional storage resources and automatically populate the selected resources into the resource-tree based on how the selected resources are defined to be related to the already provisioned resources. In these instances, the platform expert 112 may operate in conjunction with the node manager 110 where the platform expert 112 is configured to update the graphical representation 130 and the node manager 110 is configured to update the storage services located on the storage devices 114 and/or the specification of the storage service stored within the resource data structure 119.

The use of the graphical representations 130 enables the platform expert 112 to operate as a user-facing pseudo file system and provide convenient well-known file-based features. For example, the platform expert 112 is configured to enable a user to store point-in-time states/views (e.g., a snapshot) of the graphical representation 130 of the storage service. Further, the platform expert 112 may include tools that work on files and file systems for changing the resources/objects, where the file/file system is replaced with (or includes) resources/objects. Further, the node manager 110 may be configured to determine the storage configuration of a service based on the graphical representation alone (or a machine-language version of the graphical representation condensed into a two-dimensional structure), thereby eliminating (or reducing) the need for specialized tools (or experts) to extract configuration information from the platform expert 112 and/or each of the graphical representations 130.

The platform expert 112 accordingly provides a single point interface via the graphical representation 130 for the orchestration layer to quickly gather and stitch up a global view of storage service provider applications (and incorporated third-party applications from the third-party providers 106) and perform intelligent storage actions such as rebalancing. The structure of the graphical representation 130 in conjunction with the configuration of storage resources enables the platform expert 112 to parse storage services with automated tools. Further, the configuration of the platform expert 112 is configured to provide users arbitration for accessing and updating the graphical representations 130.

The platform expert 112 may use the graphical representation 130 to re-create resource topology on another system or storage service to facilitate, for example, debugging and/or serviceability. The platform expert 112 may also use the graphical representation 130 to re-create storage service set-ups independent of MAC addresses because the individual resources/objects of the graphical representation 130 are identified based on UUIDs and not any hardware-specific identifiers. Further, the platform expert 112 may synchronization the provision of the storage service represented by the graphical representation 130 with other storage services based on the same resource architecture/configuration. For example, in clustered environments, node managers 110 across cluster members or service providers may participate in synchronizing states for storage services. The nature of the graphical representation 130 as an abstraction of the storage services provides coherency across multiple platform experts 112 and/or distributed graphical representations 130.

In an example, initial boot-up synchronization instantiates the platform expert 112, which is configured to communicate with a device discovery daemon for the hardware specific resources/objects needed to prepare the graphical representation 130 or resource-tree. The node manager 110 uses the graphical representation 130 to annotate the resources/objects within the corresponding roles by accessing the roles/objects/resources from the resource data structure 119 (created at installation or provisioning of a storage service). It should be appreciated that the data structure 119 also includes the hardware resource information for object creation within the graphical representation 130 by the platform expert 112.

It should be appreciated that the combination of the node manager 110 with the platform expert 112 provides consistency in storage object identification and representation for users. The use of the graphical representation 130 of storage services enables the platform expert 112 to provide a streamlined interface that provides a sufficient description (and modification features) of the underlying storage resources. The graphical representations 130 managed by the platform expert 112 accordingly serves as the source of truth and authoritative source for configurations, state, status, and statistics of the storage service and underlying storage resources. Further, any changes made to resources/objects by the third-party providers are identified by the platform expert 112 to be reflected in the appropriate graphical representations 130.

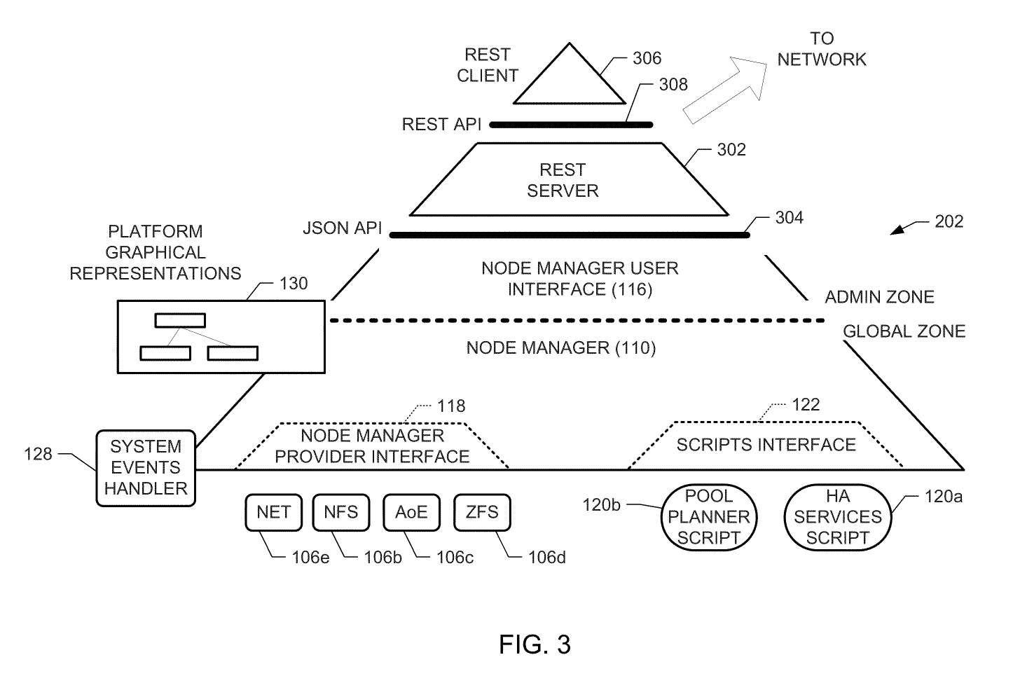

FIG. 3 shows a diagram of access layers to the example node manager 110, according to an example embodiment of the present disclosure. As discussed above in conjunction with FIG. 1, the example node manager 110 communicatively couples to the user devices 104 via the user interface 116, which may be located within an administrator zone of the storage service provider 102. The user interface 116 may be connected to the user devices 104 via a REST server 302 and a JSON API 304. The REST server 302 may be connected to the user devices 104 via a REST Client 306 and a REST API 308. The REST server 302 and/or the REST Client 306 may be configured to authenticate and/or validate user devices 104 prior to transmitting requests to the node manager 110. Such a configuration ensures that the user devices 104 provide information in a specified format to create/view/modify storage services. Such a configuration also enables the user devices 104 to view/modify storage services through interaction with the graphical representation 130. The configuration of interface components 302 to 308 accordingly enables the user devices 104 to submit requests to the node manager 110 for storage services and/or access graphical representations 130 to view an abstraction of storage services.

The example node manager 110 is connected within a global zone to the third-party providers 106 via the provider interface 118. The third-party providers 106 access the interface 118 to modify, add, remove, or otherwise update storage resources at the node manager 110. The node manager 110 is configured to propagate any changes to storage resources through all instances and copies of the resource used within different storage services. Such a configuration ensures that any changes to storage resources made by the third-party providers 106 are reflected throughout all of the hosted storage services. This configuration also places the third-party providers 106 in charge of maintaining their own resources (and communicating those changes), rather than having the node manager 110 query or otherwise obtain updates to storage resources from the providers 106. As discussed above, the example system events handler 128 monitors for any changes made to the storage resources and transmits one or more messages to the platform expert 112 indicating the changes, which enables the platform expert 112 to update the appropriate graphical representations 130.

The example node manager 110 is also connected within a global zone to scripts 120 (e.g., the pool planner script 120b and the HA services script 120a) via the scripts interface 122. The scripts interface 122 enables external and/or internal scripts and tools to be made available by the node manager 110 for user management of storage services. The scripts 120 may be located remotely from the node manager 110 and plugged into the node manager 110 via the interface 122.

### Flowcharts of Example Procedures

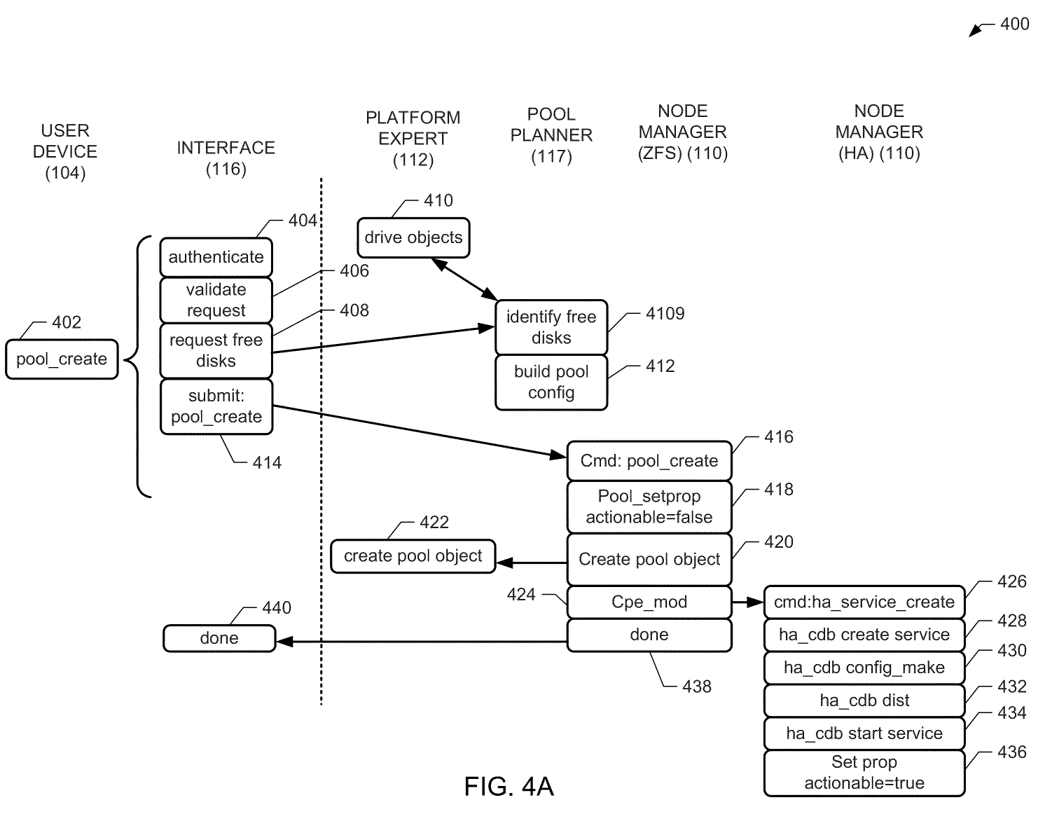

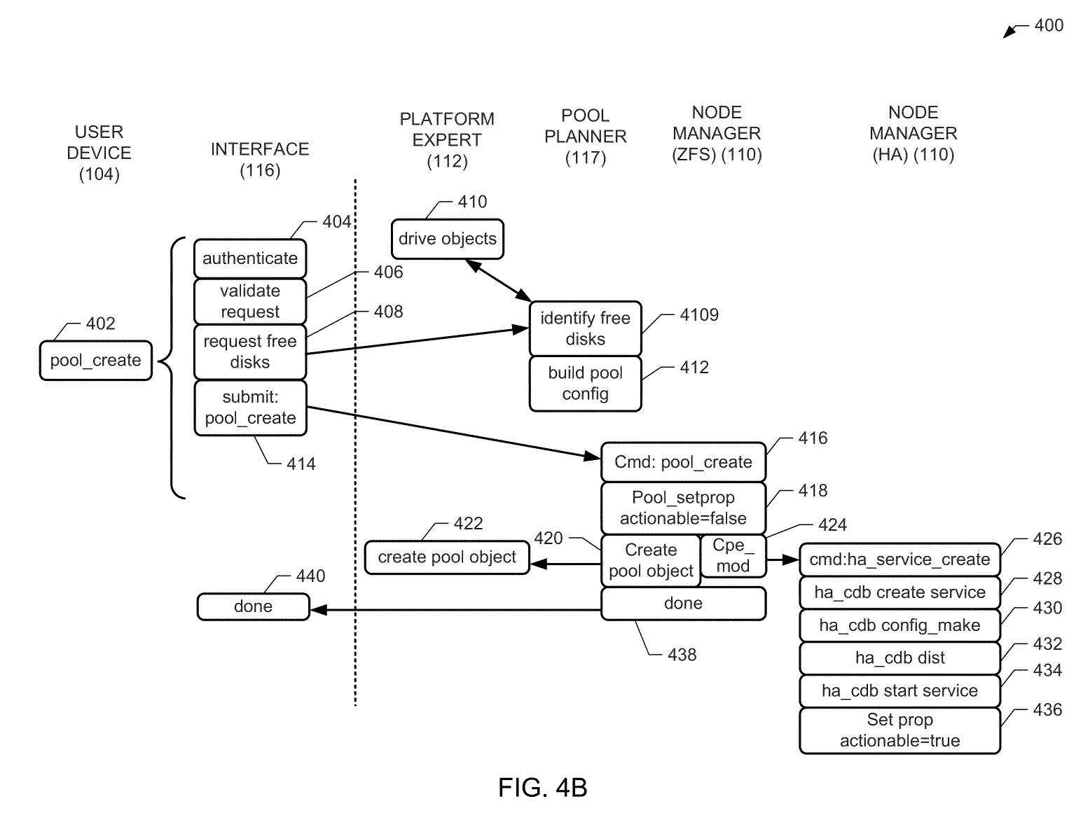

FIGS. 4A, 4B, 5, 6, and 7 illustrate flow diagrams showing example procedures 400, 500, 600, and 700 to create, destroy, and import a storage service using the example node manager 110 and/or the platform expert 112 of FIGS. 1 to 3, according to example embodiments of the present disclosure. Although the procedures 400, 500, 600, and 700 are described with reference to the flow diagrams illustrated in FIGS. 4A, 4B, 5, 6, and 7, it should be appreciated that other approaches to create, destroy, and import a storage service are contemplated by the present disclosure. For example, the order of many of the blocks may be changed, certain blocks may be combined with other blocks, and many of the blocks described are optional. The example procedures 400, 500, 600, and 700 need not be performed using the example node manager 110 and the platform expert 112, but may be performed by other devices. Further, the actions described in procedures 400, 500, 600, and 700 may be performed among multiple devices including, for example the user device 104, the interfaces 116, 118, 122, and 124, the system events handler 128, the node manager 110, the pool planner 117, the platform expert 112, and more generally, the storage service provider 102 of FIGS. 1 to 3.

FIG. 4A shows a diagram of a procedure 400 to create a storage service (e.g., a service pool). Initially, before (or immediately after) a user requests the service pool, at least a portion of the storage devices 114 of FIG. 1 are determined to be available, with at least one storage cluster being configured for use by a user. Additionally, at least one storage node is operational and available for the user. To create the storage service, the user device 104 transmits a pool create command or message to the user interface 116 of the storage service provider 202 (block 402). The example interface 116 (or the REST API 308) is configured to authenticate and validate the pool request (blocks 404 and 406). The interface 116 (using the information from the user) also communicates with the pool planner 117, the platform expert 112, and/or the node manager 110 to determine free/available space on the storage devices 114 (blocks 408, 409, and 410). The pool planner 117 may also be configured to create or build a configuration for the storage pool, which may be stored to the resource data structure 119 (block 412). It should be appreciated that the user, via the user device 104, specifies the configuration resources, parameters, properties, and/or objects for the storage service using the interface 116. The interface 116 also submits an instruction or command including the configurations to the node manager 110 to create the storage pool (block 414). The code below shows an example storage pool creation commend.

```
{
      “command”: “pool_create”,
      “version”: “1.0”,
      “type”: “request”,
      “parameters”: {
          “attributes”: {
                “alias”: “”,
                “kind”: “PHYSICAL”,
                “aoe_pool_num”: 42,
                “intent”: “BLOCK”
                },
          “config”: [
          {
                “redundancy”: “RAIDZ2”,
                “drives”: [
                “a38220a7-bfef-5fdc-bfd1-9e887b585f66”,
                “04a2a3ff-e13b-505a-8996-4f114f7dbe38”,
                “25b755ac-f669-52cb-bda4-5db346be61b6”,
                “d8fc75d6-b92a-5757-8f86-4b7826fac864”,
                “a0441297-e9d8-5f5c-8a92-be5f1cddd2bb”,
                “8cfaaa33-3886-577f-802d-1096dbca68dd”,
                “698e3af7-a811-53f0-af6d-280637cf5be1”,
                “e61051d6-3ef3-5cba-abdf-6753c4c8018d”,
                “8bae596b-4083-5156-a98e-c9e91f43c6ce”
                ]
          },
          {
                “redundancy”: “RAIDZ2”,
                “drives”: [
                “721080fc-f024-5a28-a172-d6c2e25685a5”,
                “3a8eb214-2874-5d0f-99bc-6e161ec56998”,
                “9c2e3e88-5b51-592c-88d2-61c3b8257fd3”,
                “88849795-dfc8-5c79-b265-9adac1f3e6b5”,
                “c763c71d-711b-55f4-bf4f-c216ad1dd0ae”,
                “e6e8edf0-6005-5991-aab6-c0292b278360”,
                “f868c239-97d1-594b-b154-a28e707d2000”,
                “a7b99135-f36e-555a-b811-b5ba416e09d9”,
                “f254b626-9608-5ace-86de-be79c4befa10”
                ]
        }
        ]
      }
}
```

The example node manager 110 is configured to translate the above command with the configurations of the storage pool to a sequence of storage functions (e.g., ZFS functions) and system calls that create or provision the storage pool/service among the storage devices 114. For instance, a ZFS component or application within the node manager 110 (or accessed externally at a third-party provider) receives the storage pool create command and auto-imports the storage pool (e.g., makes the storage pool available and/or accessible on at least one node) (blocks 416 and 418). The ZFS component also generates a pool-import event to advertise the coming online of the new storage resources located within or hosted by the storage devices 114 (block 420). The system event handler 128 is configured to detect the advertisement and send a message to the platform expert 112 indicative of the coming online of the new storage pool. The advertisement may include a UUID of the storage pool. In response, the platform expert 112 creates a graphical representation of the storage pool including resources and/or objects of the pool by calling or accessing the node manager 110 using the UUID of the storage pool to determine or otherwise obtain attributes, properties, objects of the newly created storage pool (block 422).

The example ZFS component of the node manager 110 is also configured to transmit a command to a HA component of the node manager 110 to further configure and/or create the storage pool (block 424). In response to receiving the command, the HA component creates the HA aspects or functions for the storage pool including the initialization of the storage pool service (blocks 426 to 436). It should be appreciated that ‘ha_cdb’ refers to a high availability cluster database. In some embodiments, the ‘ha_cdb’ may be implemented using a RSF-1 failover cluster. The node manager 110 transmits a completion message to the user device 104 (or the interface 116) after determining that the storage pool has been configured and made available to the user (blocks 438 and 440). At this point, the storage pool has been created, cluster service for the storage pool has been created, and all cluster storage nodes are made aware of the newly created storage pool.

FIG. 4A shows that the node manager 110 asynchronously updates the CPE (block 424) and generates the pool-import event (block 420) to cause the platform export 112 to create the graphical representation of the storage pool. In another embodiment, as shown in FIG. 4B, the node manager 110 is configured to update the CPE (block 424) inline with generating the pool-import event (block 420). Such a configuration may ensure that the graphical representation of the storage pool is created at about the same instance that the CPE is updated.

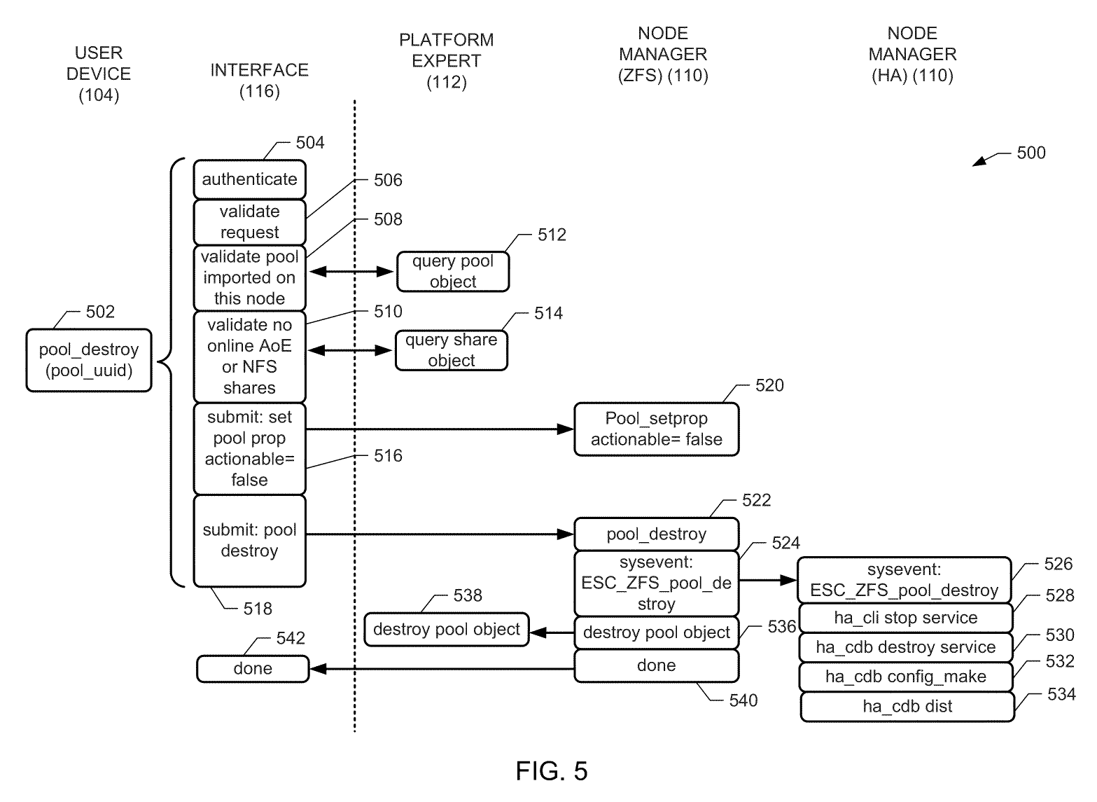

FIG. 5 shows a diagram of a procedure 500 to destroy or decommission a storage service. To begin the procedure 500, the user device 104 transmits a pool destroy command or message to the interface 116 of the storage service provider 102 (block 502). The command may include a UUID of the storage service or storage pool. The example interface 116 is configured to authenticate and validate the command or request message (blocks 504 and 506). The interface 116 also validates that the requested service pool is on a specified node and that there are no online AoE or NFS shares with other nodes (blocks 508 and 510). This includes the interface 116 accessing the platform expert 112 to query one or more storage pool objects and/or storage share objects within a graphical representation of the requested storage pool (blocks 512 and 514). Alternatively, the interface 116 may query a configuration, specification, or resource file associated with the requested storage pool located within the resource data structure 119. The example interface 116 then transmits commands to the ZFS component of the node manager 110 to destroy the specified service pool (blocks 516 and 518).

The example node manager 110 uses, for example, a ZFS component and/or an HA component to deactivate and destroy the storage pool (blocks 522 to 530). The node manager 110 also uses the HA component to make recently vacated space on the storage devices 114 available for another storage pool or other storage service (blocks 532 and 534). Further, the node manager 110 transmits a destroy pool object message to the platform expert 112, which causes the platform expert 112 to remove or delete the graphical representation associated with the storage pool including underlying storage resources, objects, parameters, etc. (blocks 536 and 538). The node manager 110 transmits a completion message to the user device 104 (or the interface 116) after determining that the storage pool has been destroyed (blocks 540 and 542).

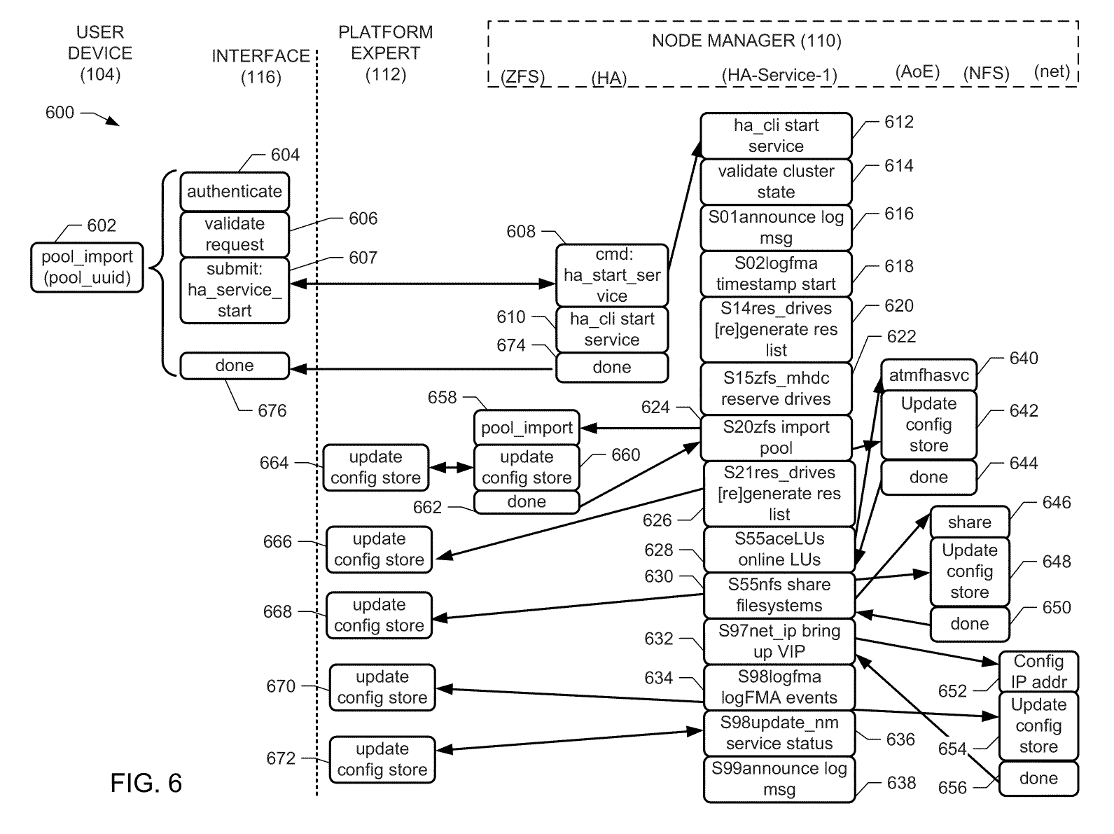

FIG. 6 shows a diagram of a procedure 600 to import a storage service. To begin the procedure 600, the user device 104 transmits a command or a request to import a storage service (e.g., a storage pool) (block 602). The request may include a UUID of the storage pool. The example interface 116 is configured to authenticate and validate the command or request message (blocks 604 and 606). The interface 116 also transmits a command or message to a HA component of the node manager 110 to begin service for the service pool to be imported (blocks 607, 608, and 610). A high availability service-1 component (e.g., a RSF-1 component) of the node manager 110 is configured to manage the importation of the service pool including the updating of clusters and nodes, reservation of disk space on the storage devices 114, assignment of logical units and addresses, and the sharing of a file system (blocks 612 to 638). The high availability service-1 component may invoke or call an AoE component for the assignment of logical units to allocated portions of the storage devices 114 (blocks 640 to 644), the NFS component to configure a file system (blocks 646 to 650), the NET component to configure an IP address for the imported storage pool (blocks 652 to 656), and the ZFS component to import data and configuration settings for the storage pool (blocks 658 to 662). The ZFS, high availability service-1, AoE, NFS, and NET components may transmit messages to update a configuration file at the node manager 110, which is stored to the resource data structure 119. The platform expert 112 is configured to detect these configuration events and accordingly create a graphical representation of the imported storage pool (blocks 664 to 672). The node manager 110 may also transmit a completion message to the user device 104 (or the interface 116) after determining that the storage pool has been imported (blocks 674 and 676).

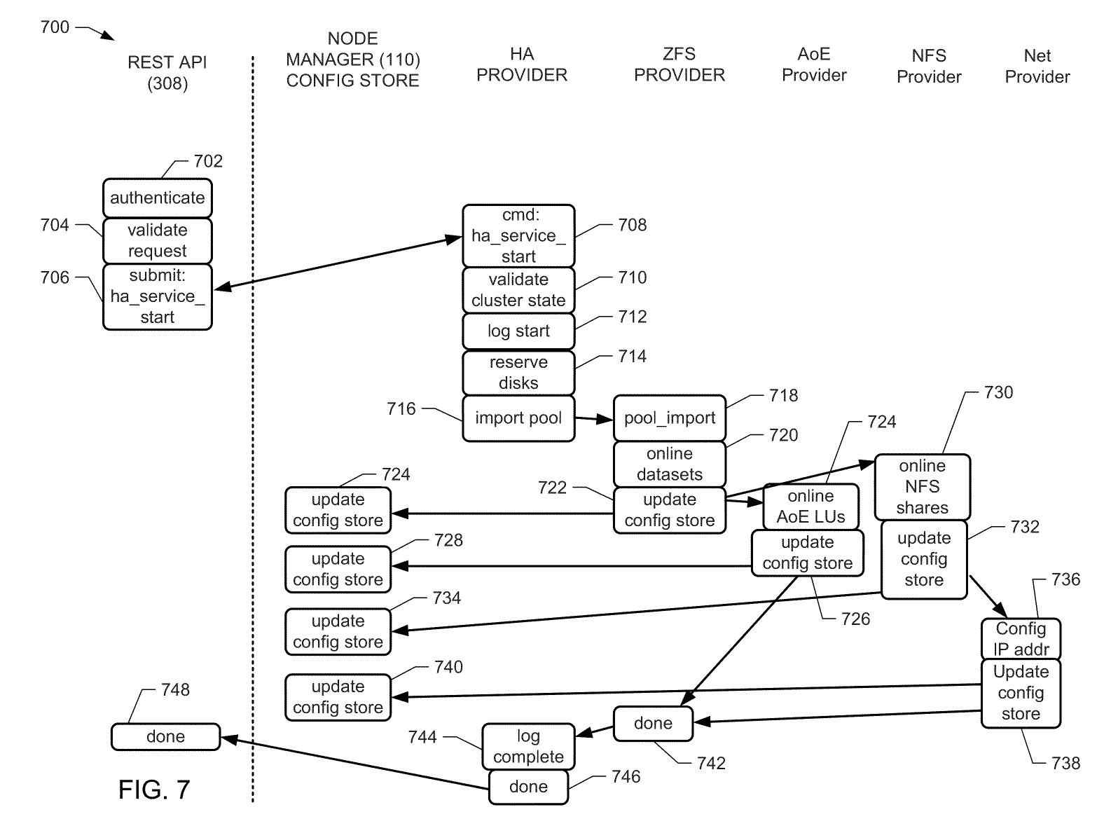

FIG. 7 shows a diagram of a procedure 700 to import a storage service according to another embodiment. The procedure 700 begins when the REST API 308 (and/or the interface 116) receives a request to import a storage service (e.g., a storage pool). The request may include a UUID of the storage pool. The example REST API 308 is configured to authenticate and validate the request message (blocks 702 and 704). The REST API 308 also transmits a command or message to a HA component of the node manager 110 (or the HA provider 106a) to begin service for the service pool to be imported (blocks 706 and 708). The HA component is configured to manage the importation of the service pool including the updating of clusters and nodes, management of a log to record the service pool importation, reservation of disk space on the storage devices 114, assignment of logical units and addresses, and/or the sharing of a file system (blocks 710 to 716).

The example HA component calls a ZFS component or provider 106d to import the service pool and bring datasets online (blocks 718 and 720). The ZFS component may invoke or call an AoE component (e.g., an AoE provider 106c) for the assignment of logical units to allocated portions of the storage devices 114 (block 724) and an NFS component to configure a file system (block 730). The NFS component may instruct the NET component to configure an IP address for the imported storage pool (block 736). The ZFS, HA, AoE, NFS, and NET components may transmit messages to update a configuration file at the node manager 110, which may be stored to the resource data structure 119 (blocks 722, 724, 726, 728, 732, 734, 738, 740). After the service pool is imported, the HA component ends the log and sends one or more messages to the node manage 110 and the REST API 308 indicating that the service pool has been imported (blocks 742 to 748). While not shown, the platform expert 112 may be configured to detect these configuration events and create a graphical representation of the imported storage pool.

### CONCLUSION

It will be appreciated that all of the disclosed methods and procedures described herein can be implemented using one or more computer programs or components. These components may be provided as a series of computer instructions on any computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An apparatus for managing storage services comprising:
a node manager processor configured to:
receive information indicating a configuration of a storage resource from a third-party service provider of the storage resource, the information including a resource data structure that includes at least one object of the storage resource, and
make the storage resource available to users of a Layer-2 storage system; and
a platform processor configured to:
receive a request from a user to create a Layer-2 storage service that specifies the storage resource for inclusion within the Layer-2 storage service,
responsive to the request, create the Layer-2 storage service that includes an instance of the storage resource as configured by the third-party service provider,
create a graphical representation of the Layer-2 storage service including the storage resource, the graphical representation including at least one node corresponding to the at least one object, and
transmit the graphical representation of the storage service to the user.

2. The apparatus of claim 1, wherein the node manager processor is configured to:
receive information describing an update to the configuration of the storage resource from the third-party service provider; and
apply the updated configuration in a persistent way to the instance of the storage resource for the user.

3. The apparatus of claim 1, wherein the updated configuration is applied in a persistent way such that the update configuration remains the same despite a move of the Layer-2 storage service, a move of the storage resource, or a reboot of the Layer-2 storage service.

4. The apparatus of claim 1, wherein the third-party service provider includes at least one of a high-availability storage provider, a network file system provider, an ATA over Ethernet (“AoE”) provider, a ZFS provider, and a NET provider.

5. The apparatus of claim 1, wherein at least one of the node manager processor and the platform processor is configured to enable the user to indicate a desired modification of the Layer-2 storage service using the graphical representation.

6. The apparatus of claim 1, wherein the at least one node includes a parameter of the at least one object.

7. The apparatus of claim 6, wherein the parameter includes at least one of an immutable parameter, a dynamic parameter, a status parameter, and a statistic parameter.

8. The apparatus of claim 1, wherein the graphical representation includes a hierarchal view of the Layer-2 storage service including a unique identifier provided in conjunction with the node.

9. The apparatus of claim 1, wherein the Layer-2 storage resource includes at least a physical resource and a virtual resource and the graphical representation includes a mapping to the at least one physical resource and the virtual resource.

10. The apparatus of claim 1, wherein the platform processor is configured to use the graphical representation as a single point interface for an orchestration layer to provide a global view of the storage resource or the Layer-2 storage service.

11. The apparatus of claim 1, wherein the node manager processor is configured to:
receive the request from the user via the platform processor;
transmit a service request message to the third-party service provider to configure the storage resource for the user; and
responsive to receiving an indication from the third-party service provider that the storage resource has been created for the user, transmit the indication to the platform processor.

12. The apparatus of claim 1, wherein the platform processor is configured to add the storage resource to the Layer-2 storage service responsive to receiving the indication from the node manager.

13. The apparatus of claim 1, wherein the user receiving the graphical representation is a first user and the user providing the request for the Layer-2 storage service is a second different user.

14. A storage service management method comprising:
receiving in a node manager processor a request from a user device to create a storage service, the request including an indication to include a storage resource within the storage service;
creating via the node manager processor the storage service including the storage resource and at least one object of the storage resource;
detecting via a system events handler the creation of the storage service;
creating via a platform processor a graphical representation of the storage service including the storage resource and the at least one object after detecting the creation of the storage service; and
transmitting to the user device at least one of the graphical representation of the storage service and graphical representation information indicating how the graphical representation is to be generated by the user device.

15. The method of claim 14, further comprising:
querying the node manager processor via the platform processor to determine attributes of the storage resource and the at least one object; and
accessing a resource library associated with the storage resource to determine how the storage resource and the at least one object are to be abstracted within the graphical representation.

16. The method of claim 14, further comprising storing within a resource file, via the node manager processor, a specification of the storage service including information related to the storage resource and an identifier of the storage service.

17. The method of claim 16, further comprising:
determining the identifier of the storage service at the system events handler after detecting the creation of the storage service;
transmitting a message from the system events handler to the platform processor, the message being indicative of the created storage service and including the identifier;
performing a call from the platform processor to the node manager processor to query information related to the storage service; and
receiving in the platform processor from the node manager processor, to enable creation of the graphical representation, the specification of the storage service including the information related to the storage resource and information related to the at least one object.

18. A storage service management apparatus comprising:
a system events handler configured to detect the creation of a storage service including interrelated storage resources and corresponding objects; and
a platform processor configured to:
determine attributes of the storage resources and the corresponding objects;
access a resource library associated with the storage resources to determine how the storage resources and the corresponding objects are to be abstracted within a graphical representation;
create the graphical representation of the storage service including the storage resources and the corresponding objects; and
transmit the graphical representation of the storage service to a user device.

19. The apparatus of claim 18, further comprising a Representational State Transfer (“REST”) server and a JavaScript Object Notation (“JSON”) application program interface (“API”) communicatively coupled to the platform processor and configured to:
receive, from the communicatively coupled user device at least one of a service level agreement (“SLA”) or requirements for the storage service;
provide the graphical representation of the storage service to the user device; and
enable a user to modify at least one attribute or object of the storage service through the graphical representation.

20. The apparatus of claim 19, further comprising a REST API and a REST client located between the user device and the REST server and the JSON API and configured to validate the user device.

21. The apparatus of claim 18, wherein the platform processor includes a pool planner script configured to create the storage service based on specifications from the user device.
